(19) United States
(12) Patent Application Publication
(10) Pub. No.: US 2017/0057572 A1
(43) Pub. Date: Mar. 2, 2017

(54) Track Joint Assembly

(71) Applicant: Caterpillar Inc., Peoria, IL (US)

(72) Inventors: David Hakes, Brimfield, IL (US); Benoit Abello, Dunlap, IL (US)

(73) Assignee: Caterpillar Inc., Peoria, IL (US)

(21) Appl. No.: 14/839,280

(22) Filed: Aug. 28, 2015

(51) Int. Cl. B62D 55/088; B62D 55/092; B62D 55/32; B62D 55/21

(52) U.S. Cl. CPC B62D 55/0887; B62D 55/21; B62D 55/092; B62D 55/32

(57) ABSTRACT

A track joint assembly pivotally links together track links of a continuous track. To form the track joint assembly, the first track link may include a male lug projecting from an edge of the track link that can be received between first and second side lugs projecting from the second track link. A floating bushing may be disposed inside a lug bore of the male lug and is in lubricated contact with the male lug. To retain the lubricant, first and second seals are disposed at either side of the floating bushing. A pin is inserted through both the floating bushing and lug apertures disposed through the first and second side lugs respectively. The pin may be in dry contact with the floating bushing and is either in a clearance fit or transition fit so that it can rotated with respect to the floating bushing.

### TECHNICAL FIELD

This patent disclosure relates generally to continuous tracks used to propel mobile machines over rugged terrains and, more particularly, to the track joint assemblies used to pivotally connect the adjacent links of the continuous track.

### BACKGROUND

Many mobile machines used in mining, construction, agriculture, and the like are supported on an undercarriage assembly that may have one or more continuous tracks or caterpillar tracks that enable the machine to traverse the ground or terrain. The continuous track may include a plurality of track links that are pivotally joined or linked together by pins, for example, and that are arranged in a continuous loop or belt similar to a closed chain. The continuous track also includes shoes or track pads disposed thereon to engage the ground. The continuous track is disposed around a plurality of wheels or rollers, sometime referred to as a bogie, arranged along a lower side of the machine and the track can be made to translate about the wheels or rollers with respect to the machine by a drive sprocket operatively coupled to the prime mover. The hinged connection between the individual track links enables the continuous track to flex and bend as it moves in a loop about the plurality of rollers and thereby bringing the track shoes into engagement with the ground.

An advantage of continuous tracks is that they can better support and distribute the weight of the machine due to the fact the continuous track provides a larger degree of surface contact with the ground and thus better traction, as compared with other forms of propulsion such as pneumatic tires or wheels. Accordingly, continuous tracks can better traverse soft or loose soil or other materials without becoming stuck or spinning out. In addition, the better traction means the continuous tracks may have better climbing capability or the ability to ride up and down steep grades in the work surface. Further, because the individual links are often made of steel or hard rubber, the continuous tracks are typically more durable than compared with pneumatic tires or the like.

To enable the track links to articulate so that the continuous track translates about the rollers and drive sprocket, the individual links must be joined by an appropriately designed track joint assembly. Further, because of the substantial forces and loads imposed on the continuous track, and the conditions in which the tracks operate, the design and construction of the track joint assembly should resist wear and contamination. One example of a track joint assembly is presented in U.S. Patent Publication No. 2013/0002010 (“the '010 publication”) that describes a track chain comprising links arranged end-to-end in two parallel, side-by-side series. To join the two parallel series of links, a cartridge extends between them that enables the adjacent links within each series to pivot with respect to each other. The cartridge includes an external bushing disposed between and contacting the parallel links and a pin disposed through apertures in the links and a passageway in the bushing. To facilitate pivoting, a lubricant may be periodically supplied to the bushing through a reservoir axially disposed in the pin. While the cartridge and lubrication facilitates pivoting, the cartridge design complicates assembly and disassembly of the continuous track. The present disclosure is directed to a track joint assembly designed to simplify the assembly and disassembly of the continuous track.

### SUMMARY

The disclosure describes, in one aspect, a track joint assembly for pivotally joining a first track link and a second track links to form a continuous track for a mobile machine. The track joint includes a first track link and a second track link both having male lugs delineating lug bores that project from edges of the respective tack links. The track links also include a first side lug delineating a first lug aperture and a second side lug delineating a second lug aperture that project from an opposite edge of the respective track links. The track joint assembly also includes a tubular floating bushing having a bushing bore and that is coaxially disposed in the lug bore and that floats with respect to the male lug. To enable the floating bushing to float, the interface between the bushing and the male lug is lubricated. A first fixed bushing is disposed in the lug bore by an interference fit at the first side of the floating bushing and is adapted to position a first seal to seal against a first side of the floating bushing. A second fixed bushing is likewise disposed in the lug bore at the second side of the floating bushing and positions a second seal against a second side of the floating bushing. To link the track links together, a pin is coaxially inserted through the floating bushing bore, the first side lug, and the second side lug.

In another aspect, the disclosure describes a method of pivotally joining a first track link to a second track link. According to the method, a floating bushing is inserted within a lug bore of a male lug projecting from an edge of the first track link. The interface between the bushing and the lug bore is lubricated with a lubricant. To seal in the lubricant, a first seal is disposed against a first side and a second seal disposed against the second side of the floating bushing. The male lug is inserted between a first side lug and a second side lug that project from a second edge of the second track link and is positioned so that the lug bore and the first and second lug aperture of the respective first and second side lugs are axially aligned. A pin can then be inserted through the bushing bore of the floating bushing to mate the track links together.

In yet a further aspect, the disclosure describes a continuous track for a mobile machine assembled from a plurality of identical track links linked together. The continuous track includes a first track link and a second track link both having a male lug, a first side lug, and a second side lug projecting from edges of the respective track links. A pin is inserted in the male lug of the first track link and the first side lug and the second side lug of the second track link. The pin is disposed in dry contact with a first floating bushing that in turn is disposed in lubricated contact with the male lug of the first track link. Similarly a second pin is inserted in the male lug of the second track link and the first side lug and the of the first track link. The second pin is also dry contact with a second floating bushing that is in lubricated contact with the male lug of the second track link.

### BRIEF DESCRIPTION OF THE DRAWINGS

FIG. 1 is side elevational view of a mobile machine in the form of a hydraulic shovel used for mining operations and the like which is supported on an undercarriage assembly having continuous tracks that can traverse over the ground or terrain.

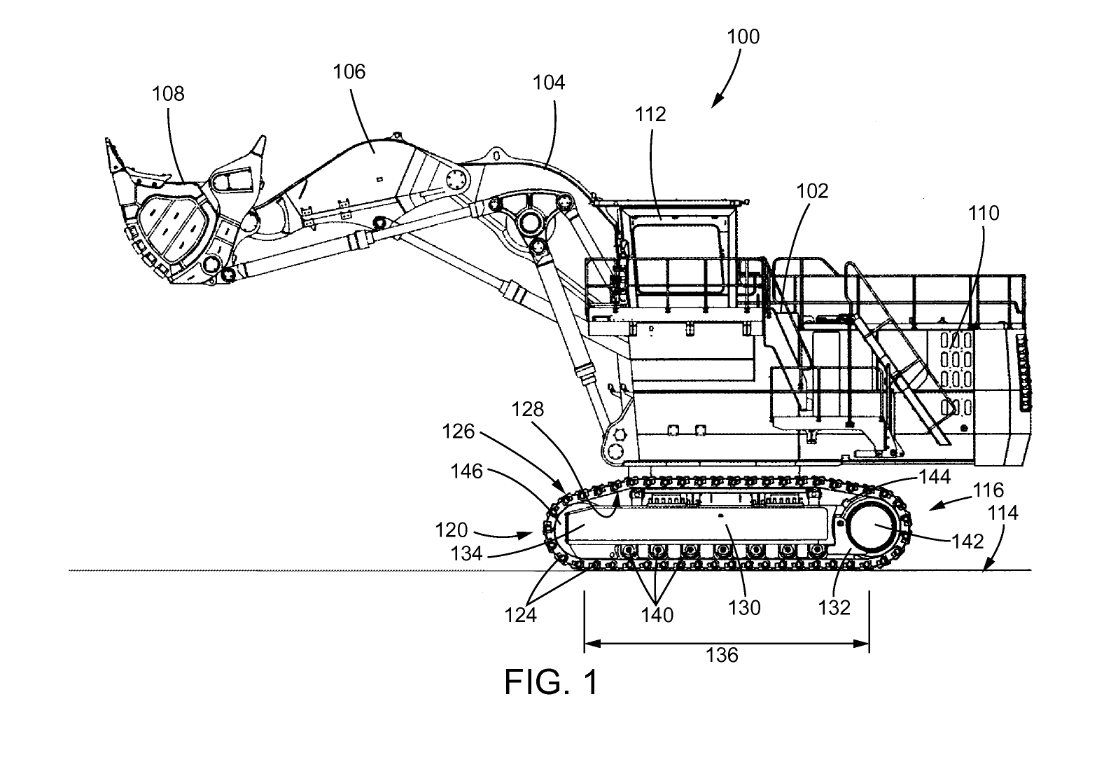

FIG. 2 is a top perspective view of an individual track link having plurality of lugs that can be mated with lugs from an identical track link to form a track joint assembly and make up the continuous track.

FIG. 3 is a cross-sectional view taken through a set of mated lugs of a track joint assembly that are linked by a floating bushing and pin configuration in accordance with the present disclosure.

FIG. 4 is a perspective assembly view of a track joint assembly illustrating the assembly of the floating bushing, pin, seals, and other components into the lugs.

### DETAILED DESCRIPTION

This disclosure relates to a machine including an undercarriage assembly having continuous tracks for traversing the ground or terrain about a work site. Now referring to the drawings, wherein like reference numbers refer to like elements, there is illustrated a machine 100 of such a type that, in particular, may be a hydraulic shovel or power shovel. However, the present disclosure is applicable to any type of machine having an undercarriage assembly and that performs some type of operation associated with an industry such as mining, construction, farming, transportation, or any other industry known in the art. For example, the machine may be an earth-moving machine, such as a track loader, excavator, continuous miner, material handler, tractor-type trailer, high-wall miner, rotary blasthole drill, or the like. Moreover, an implement may be connected to the machine. Such implements may be utilized for a variety of tasks, including, for example, loading, compacting, lifting, brushing, and include, for example, buckets, compactors, forked lifting devices, drilling, brushes, grapples, cutters, shears, blades, breakers/hammers, augers, and others.

The machine 100 embodied as a hydraulic shovel may be intended for digging, lifting, and dumping material about a worksite such as a mine and can include a machine frame 102 or chassis to which a hydraulically operated boom 104 and stick 106 are connected in an articulating manner. Disposed at the end of the stick 106 is a bucket 108 configured to dig or scoop material and move the material to another location when the boom 104 and stick 106 are moved with respect to the frame 102. In addition to or instead of hydraulics, the boom 104 and bucket 108 can be supported and moved by a rope or cable system. To provide power for manipulating the boom 104 and stick 106 and the other operations of the machine 100, a power plant 110, such as an internal combustion engine, can be disposed on the frame 102 behind vented panels attached to the frame. The power plant 110 can combust a hydrocarbon-based fuel such as diesel to convert the chemical energy therein into mechanical power and motion that can be harnessed by the other systems on the machine 100. To accommodate an operator who may control the operation of the machine, an operator's cab 112 can be disposed on top of the frame 102 in a position providing visibility about the worksite and inside of which various machine motion controls, power plant controls, gauges, and readouts are located.

To facilitate digging and loading operations, the frame 102 of the machine 100 can be pivotally mounted on an undercarriage 116 such that the frame 102 can swing the boom 104 and stick 106 around for loading or dumping loads from the bucket 108. To propel the machine 100 over the ground or surface 114 of the worksite, the undercarriage 116 can be equipped with a plurality of continuous tracks 120. While the illustrated view shows only one continuous track 120 on one side of the machine 100, one of skill in the art will appreciate that a second, generally identical track is disposed on the other side. In a further embodiment, multiple continuous tracks can be provided on each side of the machine. The continuous track 120, which may also be referred to as a caterpillar track, crawler track, or endless loop track, includes a plurality of track links 122 arranged in an end-to-end manner and joined together to form a loop or closed belt. Moreover, pivot joints or hinges, herein referred to as track joint assemblies 124, are used to join or link the track links 122 to each other so that adjacent track links are able to pivot or articulate with respect to each other and the continuous track is flexible in a manner similar to a roller chain. When arranged as a loop, the continuous track 120 can be considered as having an outer periphery 126 directed outwardly of the loop, an inner periphery 128 directed inwardly, and has a continuous length measured as one complete revolution of the loop.

The continuous track 120 can be disposed as a band or loop wrapped about a track frame 130 of the undercarriage 116, which extends between a first frame end 132 and a second frame end 134 that accordingly delineate a frame length 136. In the embodiment where the machine 100 is a hydraulic shovel, the frame length 136 may be about 9.1 meters and the continuous track may have a height of approximately 2.5 meters. The track frame 130 can be arranged generally horizontally and parallel with respect to the surface 114 so that a lower portion of the continuous track 120 is in contact with the surface 114 while another portion is directed upwards and away from the surface 114. While the terms “lower,” “upper” and the like are used in the description for orientation and reference purposes, it should be noted they are not intended as a limitation on the claims unless explicitly stated and described otherwise. When the continuous track 120 is disposed about the track frame 130, it can generally encircle the track frame around the frame length 136 between the first frame end 132 and the second frame end 134.

The continuous track 120 can be made to translate about the track frame 130 so that the machine 100 moves over the surface 114. To enable the continuous track 120 to translate with respect to the track frame 130, the track frame can include a plurality of wheels or rollers of different configurations that direct and guide the track about the frame. For example, the track frame 130 can include a plurality of rollers 140 that are rotatably disposed along a bottom of the track frame 130 and that are spaced apart with respect to the frame length 136. The rollers 140 can make rolling contact with the inner periphery 128 of the continuous track 120 so that the weight of the machine 100 transfers through the rollers to the surface 114 as the track moves underneath the rollers. In addition to the lower rollers, in an embodiment, the undercarriage 116 may also include upper rollers to guide the continuous track overhead.

To drive the continuous track 120 about the track frame 130, a drive sprocket 142 can be rotatably disposed at the first frame end 132 and is operably coupled with the power plant 110 to receive motive power. The drive sprocket 142 is a wheel-like structure having a plurality of drive teeth 144 protruding radially therefrom that can engage with the track links 122 in the manner described below. Further, the drive sprocket 142 can be reversibly coupled with the power plant 110 so that it can selectively translate the continuous track in either a clockwise or counter-clockwise direction. To maintain tension across the continuous track 120, the track frame 130 can also include a wheel-like idler 146 rotatably disposed at the second frame end 134 that is in rolling contact with the inner periphery 128. In an embodiment, the rollers 140, drive sprocket 142, and/or the idler 146 can be supported on a suspension system to improve traction and enable smooth motion of the machine over the ground. The continuous track 120 wraps and bends around the drive sprocket 142 and the idler 146 that are located at the first and second frame ends 132, 134 respectively to form a closed loop.

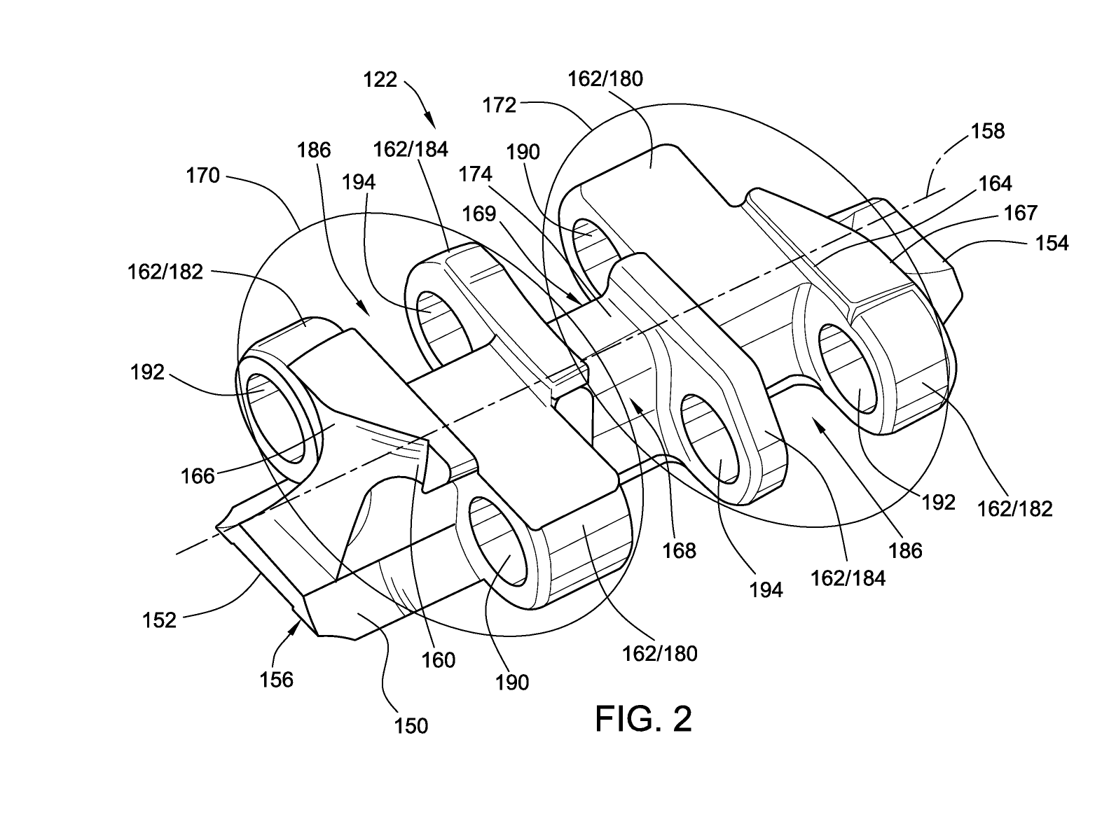

Referring to FIG. 2, there is illustrated an individual track link 122 removed from and independent of the assembled continuous track. In an embodiment, the continuous track can be made of a plurality of identical track links 122 that are joined together, one-by-one, in an articulating manner. The use of identical track links 122 simplifies the construction of the continuous track and the replacement of any individual track link 122. To contact the ground or terrain, the individual track links 122 include a shoe portion 150 that extends from a first shoe edge 152 to a second shoe edge 154 thereby defining the width of the continuous track. The shoe portion 150 also includes a lower planar surface 156 that may be generally rectangular in shape and that is planted adjacent the ground during operation. The first shoe edge 152 and the second shoe edge 154 may correspond to the narrower sides of the rectangular shaped lower planar surface 156 and thus the longer dimension of the rectangle may correspond to the track width. For reference purposes, the track width can be associated with a width axis 158 that extends between the midpoints of the first shoe edge 152 and the second shoe edge 154. However, in other embodiments, the shoe portion 150 may have shapes other than strictly rectangular.

To facilitate linking with other identical track links, the track link 122 may include a link body 160 protruding upward from the shoe portion. In the illustrated embodiment, the shoe portion 150 and the link body 160 may be integrally formed but in other embodiments, the shoe portion and the link body can be separate components that are secured together by, for example, fasteners. The link body 160 can include a plurality of lugs 162 of various styles that can be mated together to join adjacent track links. The plurality of lugs 162 may be joined to and project from a contiguous spine 164. The contiguous spine 164 extends between a first body side 166 and a second body side 167 generally along the shoe portion 150 and is aligned in parallel with the width axis 158. In the illustrated embodiment, the contiguous spine 164 may be shorter that the rectangular shoe portion 150 but in other embodiments the contiguous spine 164 and shoe portion 150 may be coextensive with each other. The contiguous spine 164 further delineates a first edge 168 and an opposing second edge 169 that run generally parallel with the width axis 158 and from which the plurality of lugs 162 project.

The plurality of lugs 162 may project from the contiguous spine 164 in directions perpendicular to the width axis 158 of the track link 122. Further, the plurality of various lugs 162 may be arranged into a first group 170 of lugs and a second group 172 of lugs. The first group 170 of lugs may be associated with and disposed proximate to the first body side 166 and a second group 172 of lugs may be associated with and disposed proximate to the second body side 167. The first group 170 of lugs and the second group 172 of lugs may be separated by a drive beam 174 that is located generally mid-way between the first body side 166 and the second body side 168 and that corresponds to and forms part of the contiguous spine 164. The drive beam 174 may be relatively narrow and recessed or retracted within the projecting lugs 162 of the first and second groups 170, 172. The first group and second group 170, 172 may include lugs 162 of each style and may be substantially identical in the number and styles of lugs included. However, the orientation of directions in which the lugs 162 project with respect to the contiguous spine 164 and the width axis 158 may be reversed between the first group 170 of lugs and the second group 172 of lugs.

Each of the first and second groups 170, 172 may include a male lug 180 that is joined to and centrally disposed between two oppositely directed, spaced apart side lugs that include a first side lug 182 and a second side lug 184. More particularly, the central male lug 180 may project from the contiguous spine 164 in one direction perpendicular to the width axis 158 while the first and second side lugs 182, 184 project perpendicular to the width axis in the opposite direction. The spaced apart, bifurcated arrangement of the first side lug 182 and the second side lug 184 may provide a lug gap 186 therebetween. The first and second side lugs 182, 184 may have the same overall shape or may be substantially different in shape to perform different functions with regards to the continuous track.

The male lug 180 may have a lug width 188 that is wider than the first and second side lugs 182, 184 and may have disposed therein a lug bore 190 that is offset from the contiguous spine 164. The first and second side lugs 182, 184, being narrower than the male lug 180, may have disposed in them a respective first lug aperture 192 and a second lug aperture 194 that are also offset from the contiguous spine 164. Hence, the lug bore 190 is generally longer or deeper than the first and second lug apertures 192, 194. The lug bore 190 and the first and second lug apertures 192, 194 may all be circular in cross-section. Further, the axis of the lug bore 190 and the first and second apertures 192, 194 may be offset from and parallel to the width axis. As stated, the first group 170 of lugs and the second group 172 of lugs may be substantially the same but for the direction of the lug projections being reversed.

To mate the lugs and join the track links 122, two identical track links 122 may placed adjacent to each other so that the male lug 180 of one track link 122 is appositionally facing the first and second side lugs 182, 184 of the other track link 122. The male lug 180 can be inserted into the lug gap 186 between the bifurcated first and second side lugs 182, 184, which may be sized to receive the male lug 180. When appropriately inserted, the lug bore 190 of the male lug 180 can axially aligned with the first and second lug apertures 192, 194 disposed in the respective first and second side lugs 182, 184. As described below, pins can be inserted into the aligned lug bore 190 and the first and second lug apertures 192, 194 to pivotally join the two track links 122 in a hinge-like manner. When the lugs are appropriately mated, the drive beam 174, which was recessed or retracted between the projecting lugs of the first and second groups 170, 172, remains spaced apart from the drive beam 174 of the adjacent track link 122. Hence, the first and second edges 168, 169 proximate the drive beam 174 are free to contact and be urged against by the teeth of the drive sprocket 142 during operation. In the embodiments where the first and second groups 170, 172 of lugs are mated with the first and second groups on an adjacent track link 122, two pins may be disposed on either side of the drive beam 174.

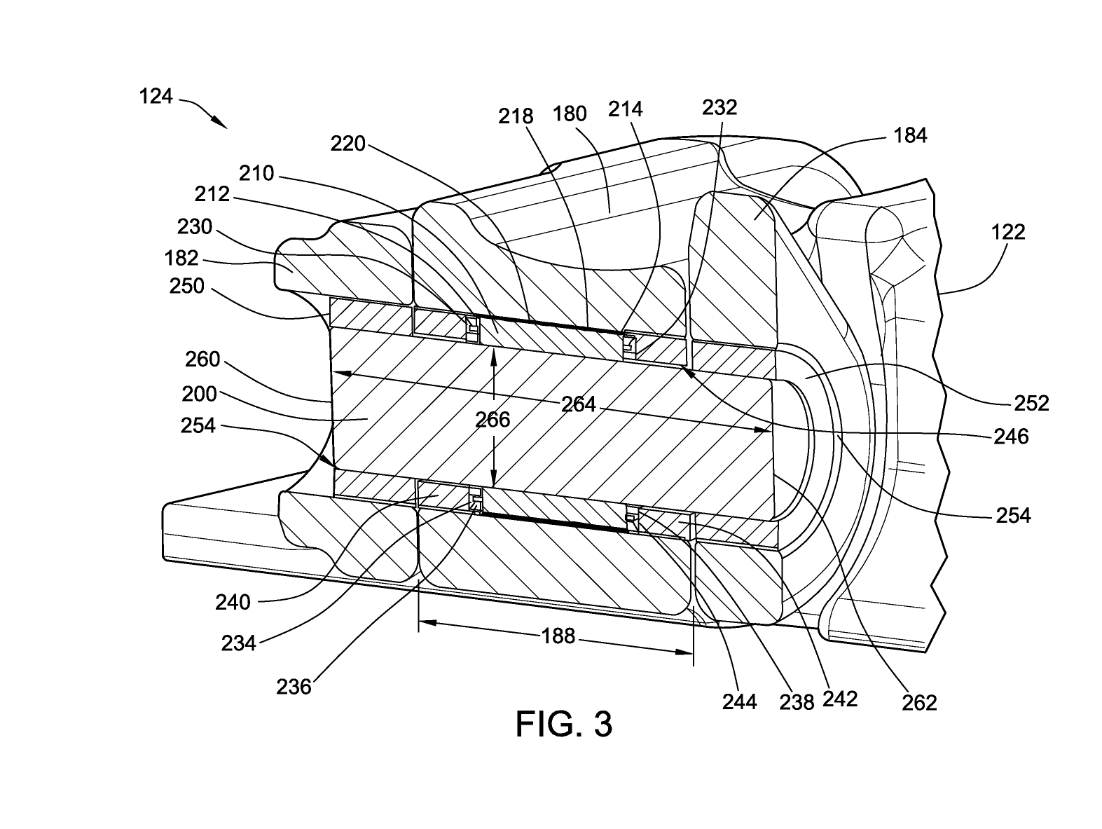

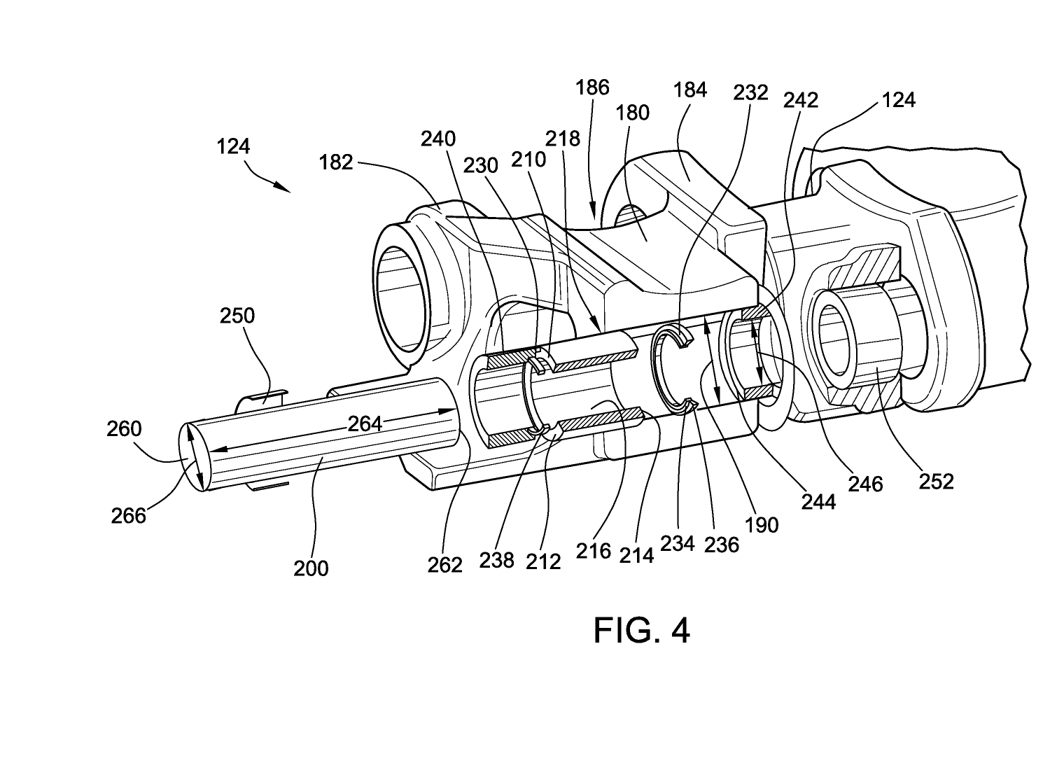

Referring to FIGS. 3 and 4, to pivotally link the lugs 162 of, for example, the first group 170 on one track link 122 with lugs of the first group on an adjacent track link, a pin 200 can be inserted through the lug bore 190 and the first and second lug apertures 192, 194 to form a hinge or pivoting joint between adjacent track links allowing them to articulate. The lugs 162 associated with the second group 172 may be pivotally linked with a pin 200 in the same manner. To facilitate assembly of the lugs 162 and the pin 200 and promote the pivoting characteristic of the connection, the lugs 162 and pin 200 can be operatively associated with additional components to form a track joint assembly 124. The additional components can include a floating bushing 210 coaxially inserted into the lug bore 190 that is disposed in the male lug 180. The floating bushing 210 may be a tubular shaped component extending between a first side 212 and a second side 214 and that delineates or extends around an internal, coaxial bushing bore 216. The dimension of the floating bushing 210 between the first side 212 and the second side 214 may be smaller than a lug width 188 of the male lug 180 so that the floating bushing 210 is disposed entirely within the lug bore 190 and enveloped by the male lug 180. The floating bushing 210 may be made from any suitable material such as, for example, metal or ceramic.

To allow the floating bushing 210 to float within the lug bore 190, the circumference of the floating bushing 210 and diameter of the lug bore 190 may be dimensioned to produce a clearance fit. The clearance fit allows the floating bushing 210 to reciprocally slide and rotate freely within the male lug 180. The amount of the clearance fit between the lug bore 190 and the floating bushing 210 may be enough to provide a measurable clearance 218 or gap between the male lug and the floating bushing. To facilitate the floating relation between the floating bushing 210 and the male lug 180, a lubricant 220 such as grease may be disposed into the clearance 218 between the floating bushing and the lug bore 190. Hence, any contact between the floating bushing 210 and the male lug 180 is a lubricated contact. The lubricant 220 can be a viscous fluid such as a hydrocarbon- or silicon-based lubricant with thickeners added to provide the desired viscosity. The lubricant 220 may be deposited into the lug bore 190 either prior to insertion of the floating bushing 210 or injected into the clearance 218 after insertion.

To seal the clearance 218 and retain the lubricant 220 therein, a pair of annular seals including a first seal 230 and a second seal 232 can be installed in the lug bore 190. The first seal 230 may be positioned against the first side 212 of the floating bushing 210 and the second seal 232 may be positioned against the second side 214, respectively, and the seals may further urge against the floating bushing 210 to ensure that an adequate seal is maintained. In an embodiment, the first seal 230 and the second seal 232 may be face seals or mechanical seals that enable relative rotation of the components. The mechanical seal may include an annular sealing member 234 that makes sliding contact with the first or second sides 212, 214 of the floating bushing 210 and that is urged against the sides by a load ring 236. The sealing member 234 may be made of a material such as graphite or silicon that enables the sliding contact and the load member may be made of a resilient material such as an elastomer or spring metal to resiliently urge the components together. Additionally, the mechanical seal may include an inner ring 238, disposed radially inward of the sealing member 234 and the load ring 236, to prevent contamination from entering the seals and interfering with the components. In other embodiments, the first and second seals 230, 232 may be of a different design such as lip seals or o-rings.

To position and retain the first and second seals 230, 232 against the respective first and second sides 212, 214 of the floating bushing 210, a first fixed bushing 240 and a second fixed bushing 242 can be coaxially installed into the lug bore 190. To fix the first and second fixed bushings 240, 242 with respect to the male lug 180, the circumference of the first and second fixed bushings 240, 242 and the diameter of the lug bore 190 may be dimensioned to produce an interference fit that prevents relative motion between the components. Because of the interference fit, the first fixed bushing 240 and the second fixed bushing 242 must be press-fit into the lug bore 190 during installation. To accommodate the first and second seals 230, 232, the first and second fixed bushings 240, 242 can include a groove 244 or a counter bore disposed into the axial face that is oriented toward the floating bushing 210. The thickness or width of the fixed bushings 240, 242 may be such that, when horizontally stacked with the first and second seals 230, 232 and the floating bushing 210, the components are all completely accommodated in the lug bore 190 and enveloped by the lug width 188 of the male lug 180. To enable insertion of the pin 200 into the male lug 180, the first and second fixed bushings 240, 242, can be annular in shape and have an inner diameter 246 dimensioned larger than the pin 200 to produce a clearance fit.

The joint assembly 124 may also include components disposed within the first and second side lugs 182, 184 to accommodate and interact with the pin 200. In particular, a first collar 250 and a second collar 252, both annular in shape, can be coaxially disposed in the respective first lug aperture 192 and the second lug aperture 194 by an interference fit. Hence, the first and second collars 250, 252 may be press-fit during installation into the first and second side lugs 182, 184. To interface with the pin 200, the first collar 250, and the second collar 252 can each include a collar aperture 254 disposed therein. The width of the first and second collars 250, 252 can be coextensive or, in various embodiments, less than coextensive with the corresponding width of the first and second side lugs 182, 184. The first and second collars 250, 252, like the first and second fixed bushings 240, 242, can be made from any suitable material such as metal.

To pivotally secure the track joint assembly 124 together, the pin 200 is coaxially inserted through the other components of the assembly. The pin 200 may be cylindrical in shape and extends from a first pin end 260 to a second pin end 262. In an embodiment, to resist the torsion and sheer stresses applied by pivotally holding the mated lugs together, the pin 200 may be solid and may be made of a metallic material. In an embodiment, the pin length 264 between the first pin end 260 and the second pin end 262 may be dimensioned so that the pin 200 is entirely accommodated within the track joint assembly 124. In particular, the pin length 264 is greater than the lug width 188 of the male lug 180 so that the first pin end 260 is disposed in the first collar 250 retained the first side lug 182 and the second pin end 262 is disposed in the second collar 252 retained in the second side lug 184. However, the pin length 264 may be coextensive with or, in an embodiment, less than coextensive with, the combined dimensions of the first side lug 182, the male lug 180, and the second side lug 184. Hence, the first pin end 262 terminates in the first collar 250 and the second pin end 264 terminates in the second collar 254. The pin 200 is therefore enveloped or enclosed by the lugs for protection and is largely unexposed to the operating environment of the continuous track. In an embodiment, to prevent contaminants like dirt or moisture from entering the apertures and bores and to help retain the pin 200, disposable caps or plugs can be fit into the collar apertures 254.

The cylindrical pin 200 can have a pin diameter 266 that enables the pin 200 to float with respect to the other components of the track joint assembly 124. In particular, the pin diameter 266 can be dimensioned to form a clearance fit or a transition fit with the floating bushing 210. A transition fit is one where the components, such as a shaft in a hole, may be held with precise tolerances so that the shaft is generally frictionally retained therein but may be removed by sliding the shaft out. A transition fit is distinguished from a clearance fit that allow the shaft and hole to move freely with respect to each other and from an interference fit in which the shaft must be press-fit into to hole resulting in compressive forces between the components. The pin 200 may also form either a clearance fit or a transition fit with the first collar 250 and the second collar 252. As indicated above, the pin 200 may form a clearance fit with respect to the first and second fixed bushings 240, 242 and can readily protrude through the fixed bushings.

### INDUSTRIAL APPLICABILITY

Referring to FIG. 3, the disclosure provides a track joint assembly 124 for pivotally linking adjacent track links 122 of a continuous track for a large sized mobile machine, such as a hydraulic shovel. In particular, a pin 200 is inserted through a male lug 180 mated between a first side lug 182 and a second side lugs 184 of adjacent track links. In the embodiments where two groups 170, 172 of lugs are disposed to either side of the narrow drive beam, two pins 200 can be utilized to mate the lugs and join adjacent track links. To facilitate assembly and disassembly of the continuous track in the field, the pin 200 can float with respect to the male lugs 180 and the first and second side lugs 182, 184 so that the pin 200 can be readily pushed or pulled out of the lugs and disconnect the adjacent track links 122. This can simplify replacement of track links 122 that may become damaged or the repair of the undercarriage. The floating characteristic of the pin 200 is due to the transition fits or clearance fits it forms with the components disposed inside of the lugs, including the floating bushing 210, fixed bushings 240, 242, and the collars 250, 252.

To accommodate the stresses from retaining adjacent track links 122 together, including tension forces, that may concentrate approximately mid-length of the pin 200 between the first and second pin ends 260, 262, while enabling the track joint assembly 124 to pivot or articulate, the center portion of the pin is retained in the floating bushing. In particular, the transition fit or clearance fit between the pin 200 and the bushing bore 216, and the bearing surface provided by the bushing bore, enable the pin to rotate with respect to the floating bushing 210 thereby providing a first degree of pivot-enabling rotation. If, however, the coefficient of friction between the pin 200 and the floating bushing 210 due, for example, the dry contact between the components and their relative weights, the floating bushing 210 may at times rotate with the pin 200 with respect to the male lug 180 when the adjacent track links 122 pivot or articulate. The floating arrangement of the floating bushing 210 with respect to the male lug 180 can accommodate this possibility, thereby providing a second degree of pivot-enabling rotation.

To enable the floating bushing 210 to rotate with respect to the male lug 180, the floating bushing and the lug bore 190 are dimensioned to produce a clearance 218 between them. A lubricant 220, such as viscous grease, can be deposited in the clearance 218 to lubricate relative motion between the floating bushing 210 and the male lug 180. To retain the lubricant 220, a first seal 230 and a second seal 232 can be positioned against the respective first side 212 and second side 214 of the tubular floating bushing 210 to hermetically seal the clearance 218. The first seal 230 and the second seal 232 may be fixed in position with respect to the male lug 180 by operative association with respective to the first and second fixed bushing 240, 242 press-fit into the lug bore 190. The permanent, fixed arrangement of the first and second seals 230, 232 creates a permanent lubrication boundary between the floating bushing 210 and the male lug 180, i.e., a permanent seal. This configuration of fixed first and second seals 230, 232, and the transition or clearance fit between the pin 200 and the floating bushing 210, reduces the possibility of damage to the first and second seals when the pin 200 is inserted and removed from the lug bore 190. Additionally, this configuration reduces maintenance because the grease 220 does not require replenishment.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A track joint assembly comprising:
a first track link including a male lug projecting from a first edge of the first track link, the male lug including a lug bore disposed therein;
a second track link including a first side lug having a first lug aperture and a second side lug having a second lug aperture, the first side lug and the second side lug projecting from a second edge of the second track link and being spaced apart from each other;
a floating bushing coaxially disposed in the lug bore to float with respect to the male lug, the floating bushing and the male lug in lubricated contact with each other, the floating bushing having disposed therein a bushing bore;
a first fixed bushing fixedly disposed in the lug bore at a first side of the floating bushing, the first fixed bushing adapted to position a first seal to seal against a first side of the floating bushing;
a second fixed bushing fixedly disposed in the lug bore at a second side of the floating bushing, the second fixed bushing adapted to position a second seal to seal against a second side of the floating bushing; and
a pin coaxially inserted through the bushing bore.

2. The track joint assembly of claim 1, wherein the lug bore and the floating bushing are sized to provide a clearance therebetween.

3. The track joint assembly of claim 2, further comprising a lubricant disposed in the clearance.

4. The track joint assembly of claim 3, wherein the lubricant is viscous grease.

5. The track joint assembly of claim 1, further comprising a first collar disposed in the first lug aperture and a second collar disposed in the second lug aperture.

6. The track joint assembly of claim 5, wherein each of the first collar and the second collar include a collar aperture adapted to receive the pin.

7. The track joint assembly of claim 6, wherein the pin includes a first pin end and a second pin end, the first pin end disposed in the first collar and the second pin end disposed in the second collar.

8. The track joint assembly of claim 2, wherein the first fixed bushing includes a groove to retain the first seal and the second fixed bushing includes a groove to retain the second seal.

9. The track joint assembly of claim 2, wherein the first seal and the second seal hermetically seal the clearance.

10. The track joint assembly of claim 2, wherein the first seal and the second seal are selected from a group consisting of a lip seal, a mechanical seal, and an o-ring.

11. The track joint assembly of claim 1, wherein the pin is a solid pin.

12. A method of pivotally joining a first track link to a second track link, the method comprising:
inserting a floating bushing within a lug bore disposed in a male lug projecting from an edge of the first track link to float with respect to the lug bore;
lubricating the floating bushing and the lug bore with a lubricant;
sealing the lubricant with a first seal disposed against a first side of the floating bushing and a second seal disposed against a second side of the floating bushing;
inserting the male lug between a first side lug and a second side lug projecting from a second edge of the second track link and aligning the lug bore with a first lug aperture of the first side lug and a second lug aperture of the second side lug; and
inserting a pin through a bushing bore disposed in the floating bushing.

13. The method of claim 12, wherein the pin and the floating bushing can rotate with respect to each other.

14. The method of claim 12, further comprising retaining the first seal with respect to the male lug with a first fixed bushing disposed in the lug bore and retaining the second seal with respect to the male lug with a second fixed bushing disposed in the lug bore.

15. The method of claim 13, further comprising:
installing a first collar in the first lug aperture of the first side lug; and
installing a second collar in the second lug aperture of the second side lug; wherein each of the first collar and the second collar include a collar aperture.

16. The method of claim 13, wherein the pin includes a first pin end and a second pin end, the first pin end disposed in the first collar and the second pin end disposed in the second collar.

17. A continuous track for a mobile machine comprising:
a first track link including a male lug, a first side lug, and a second side lug projecting from a first edge of the first track link;
a second track link including a male lug, a first side lug, and a second side lug projecting from a second edge of the second track link, the first track link and the second track link being identical;
a first pin inserted in the male lug of the first track link and the first side lug and the second side lug of the second track link, the first pin in dry contact with a first floating bushing disposed in lubricated contact with the male lug of the first track link; and
a second pin inserted in the male lug of the second track link and the first side lug and the of the first track link, the second pin in dry contact with a second floating bushing disposed in lubricated contact with the male lug of the second track link.

18. The continuous track of claim 17, further comprising:
a first clearance between the first floating bushing and the male lug of the first track link with a lubricant disposed in the first clearance; and
a second clearance between the second floating bushing and the male lug of the second track link with the lubricant disposed in the second clearance.

19. The continuous track of claim 18, further comprising:
a first seal positioned against a first side of the first floating bushing and a second seal positioned against a second side of the first floating bushing, the first seal and the second seal retained in the male lug of the first track link; and
a first seal positioned against a first side of the second floating bushing and a second seal positioned against a second side of the second floating bushing, the first seal and the second seal retained in the male lug of the second track link.

20. The continuous track of claim 17, wherein the first pin include a first pin end and a second pin end, the first pin end disposed in the first collar and the second pin disposed in the second collar.
